(19) United States
(12) Patent Application Publication
(10) Pub. No.: US 2013/0332071 A1
(43) Pub. Date: Dec. 12, 2013

(54) ROUTE SEARCH APPARATUS AND ROUTE SEARCH METHOD

(71) Applicant: KABUSHIKI KAISHA TOSHIBA, Tokyo (JP)

(72) Inventor: Masanobu Kumakawa, Hidaka-shi (JP)

(73) Assignee: KABUSHIKI KAISHA TOSHIBA, Tokyo (JP)

(21) Appl. No.: 13/966,651

(22) Filed: Aug. 14, 2013

Related U.S. Application Data
(63) Continuation of application No. PCT/JP2013/057924, filed on Mar. 13, 2013.

(30) Foreign Application Priority Data
May 31, 2012 (JP) 2012-124793

(51) Int. Cl. G01C 21/00

(52) U.S. Cl. CPC G01C 21/00
USPC 701/468; 701/400

(57) ABSTRACT

According to one embodiment, a route search apparatus includes an origin determination module, a destination determination module, and a search module. The origin determination module determines position of an origin, by using position data in a selected first image file and indicative of an imaging location of the first image file. The destination determination module determines position of a destination, by using position data in a selected second image file and indicative of an imaging location of the second image file. The search module searches for a route between the origin and the destination, based on the position of the origin and the position of the destination.

### CROSS-REFERENCE TO RELATED APPLICATIONS

This application is a Continuation Application of PCT Application No. PCT/JP2013/057924, filed Mar. 13, 2013 and based upon and claiming the benefit of priority from Japanese Patent Application No. 2012-124793, filed May 31, 2012, the entire contents of all of which are incorporated herein by reference.

### FIELD

Embodiments described herein relate generally to a route search apparatus and a route search method of searching for a route between an origin and the current position.

### BACKGROUND

Nowadays, route search apparatuses that search for a route between an origin and the current position are becoming widely used. In recent years, a smartphone or a tablet computer can be used as a route search apparatus by installing an application program in the smartphone or tablet computer.

If a Global Positioning System (GPS) module is provided, input of position data of an origin can be omitted while input of position data of a destination is mandatory. Without the GPS module, input of both the origin and destination is mandatory. There hence is a demand for simplifying input of the origin and destination.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing exterior of a route search apparatus according to an embodiment.

FIG. 2 is an exemplary block diagram showing an example system configuration of the route search apparatus according to the embodiment.

FIG. 3 is an exemplary block diagram showing an example system configuration of a route search method according to the embodiment.

FIG. 4 shows an example of a user interface displayed by a display processing module.

FIG. 5 shows another example of a user interface displayed by the display processing module.

FIG. 6 shows yet another example of a user interface displayed by the display processing module.

FIG. 7 is an exemplary flowchart showing a procedure of a route search processing.

FIG. 8 is a flowchart showing a procedure of determining latitude/longitude data of an origin.

FIG. 9 is an exemplary flowchart showing a procedure of determining latitude/longitude data of a destination.

FIG. 10 shows yet another example of a user interface displayed by the display processing module.

### DETAILED DESCRIPTION

Various embodiments will be described hereinafter with reference to the accompanying drawings.

In general, according to one embodiment, a route search apparatus includes an origin determination module, a destination determination module, and a search module. The origin determination module is configured to determine position of an origin, by using position data in a selected first image file and indicative of an imaging location of the first image file. The destination determination module is configured to determine position of a destination, by using position data in a selected second image file and indicative of an imaging location of the second image file. The search module configured to search for a route between the origin and the destination, based on the position of the origin and the position of the destination.

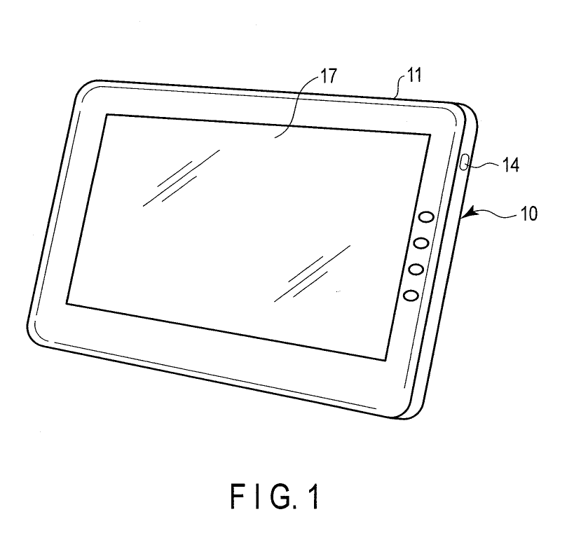

Firstly, a configuration of a route search apparatus according to the present embodiment will be described with reference to FIG. 1. The mobile route search apparatus can be manufactured as, for example, a tablet, laptop or notebook computer, a PDA, a car-navigation system, or a portable navigation device (PND). Hereinafter, descriptions will be made supposing that the route search apparatus is manufactured as a tablet computer 10 (hereinafter referred to as computer 10).

FIG. 1 is a view showing exterior of the computer 10. The computer 10 comprises a computer body 11, and a touchscreen display 17. The computer body 11 comprises a thin box-like housing. On a surface of the computer body 11, there is provided a power button 14 to power on/off the computer 10. A touchscreen display 17 is provided on the surface of the computer body 11. The touchscreen display 17 comprises a flat panel display (for example, a liquid crystal display [LCD]) and a touchpanel. The touchpanel is provided so as to cover a screen of the LCD. The touchpanel is configured to detect positions on the touchscreen display 17 touched by the user's finger or a stylus.

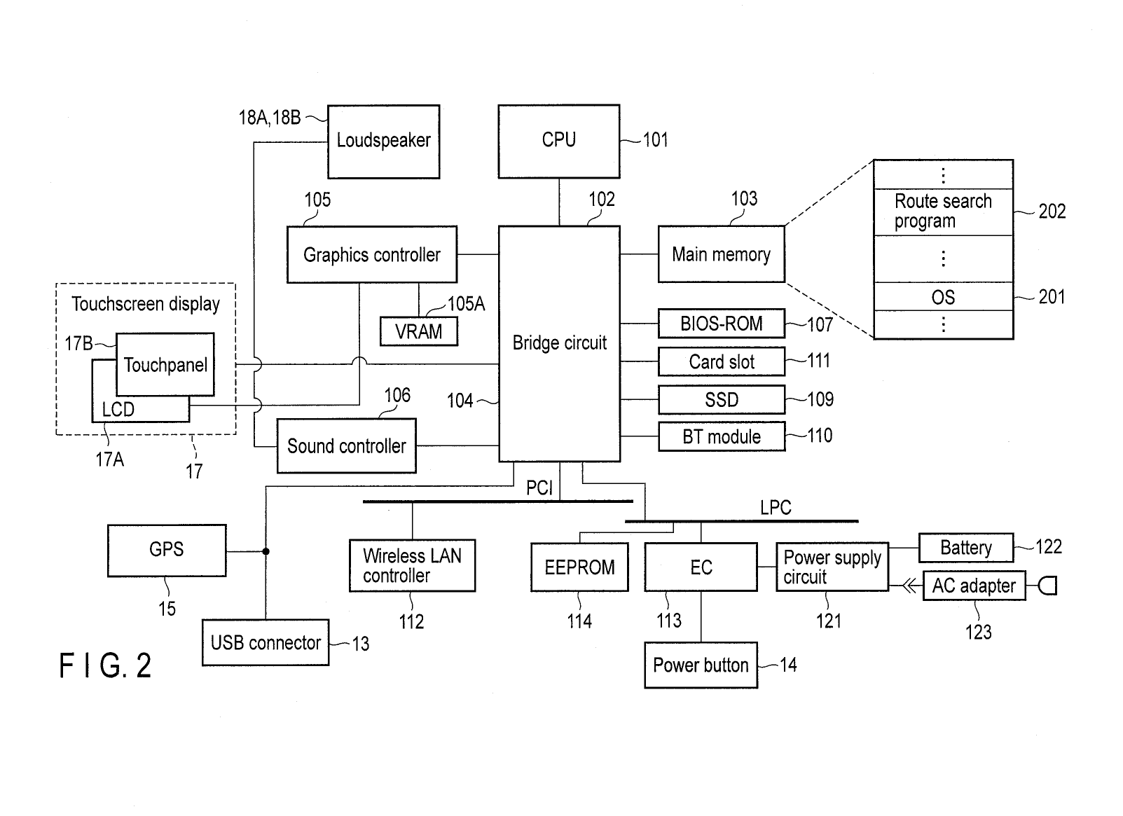

FIG. 2 is a block diagram showing an example system configuration of the computer 10.

The computer 10 comprises a central processing unit (CPU) 101, a bridge circuit 102, a main memory 103, a graphics controller (graphics processing unit [GPU]) 105, a sound controller 106, a BIOS-ROM 107, a solid-state drive (SSD) 109, a Bluetooth (BT [registered trademark]) module 110, a card slot 111, a wireless LAN controller 112, an embedded controller (EC) 113, an EEPROM 114, a USB connector 13, a touchscreen display 17, a video memory (VRAM) 105A, and the power button 14.

The CPU 101 is a processor which controls operations of individual sections in the computer 10. The CPU 101 executes an operating system (OS) 201 and various application programs which are loaded onto the main memory 103 from the SSD 109. A route search program 202 is included in the application programs.

The route-search program 202 is to search for a route between an origin and a destination which are specified by a user.

The CPU 101 also performs a basic input/output system (BIOS) stored in the BIOS-ROM 107. The BIOS is a program for hardware control.

The bridge circuit 102 is a bridge device which connects a local bus of the CPU 101 with devices on a Peripheral Component Interconnect (PCI) bus and on a Low Pin Count (LPC) bus. The bridge circuit 102 further includes a Serial Advanced Technology Attachment (ATA) controller for controlling the SSD 109. The bridge circuit 102 also functions to perform communication with the sound controller 106. Alternatively, the bridge circuit 102 may function to perform communication with the GPU 105 through a serial bus conforming to the PCI-EXPRESS standard. Still further, the bridge circuit 102 integrates a universal serial bus (USB) controller for controlling a Global Positioning System (GPS) module 15.

The GPS module 15 receives signals transmitted from four or more GPS satellites, and measures the latitude and the longitude of the current position, based on the received signal.

The GPU 105 is a display controller which controls a LCD 17A used as a display monitor of the computer 10. A video signal (also referred to as a display signal) generated by the GPU 105 is fed to the LCD 17A.

The sound controller 106 is a sound source device, and outputs the audio data as a target to reproduce, to loudspeakers 18A and 18B. The wireless LAN controller 112 is a wireless communication device which performs wireless communication conforming to the IEEE 802.11 standard, for example.

The EC 113 is an embedded controller for electric power management. The EC 113 functions to power on/off the computer 10 in accordance with operations of the power button 14 by the user. A power supply circuit 121 generates operating power to be supplied to individual components by using electric power supplied from a battery 122 in the computer 10 or electric power supplied from an external power supply, such as an AC/DC adaptor 123. Further, the power supply circuit 121 charges the battery 122 by using the electric power supplied from the external power supply.

In addition to the LCD 17A, a touchpanel 17B is built into the touchscreen display 17. The touchpanel 17B layered over the LCD 17A comprises a sensor and a microcontroller unit (MCU). If a touch operation is made on the touchpanel 17B, a position touched is detected by a sensor, and input data including the touched position on the touchpanel 17B is output by a touch controller.

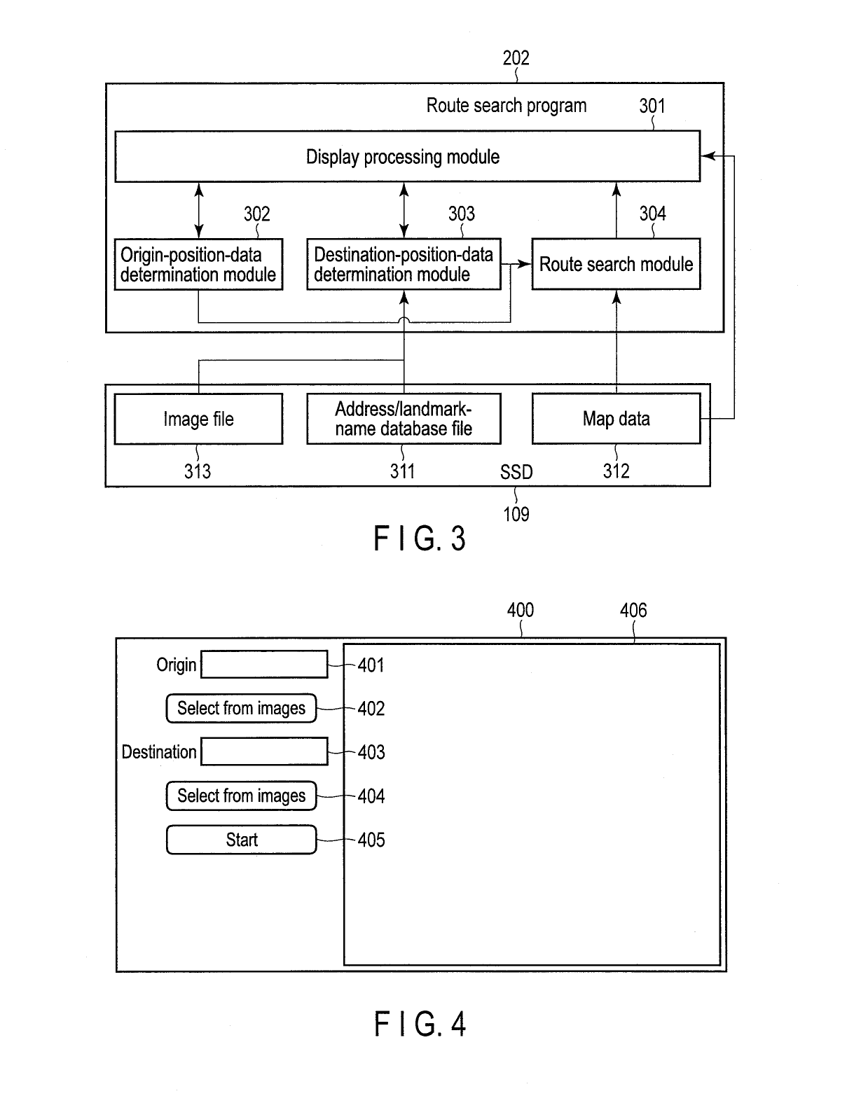

The configuration of the route search program 202 will now be described with reference to FIG. 3.

The route search program 202 comprises a display processing module 301, an origin-position-data determination module 302, a destination-position-data determination module 303, and a route search module 304. In addition, the SSD109 stores an address/landmark-name database file 311, map data 312, and image files 313. The address/landmark name database file 311 registers address data which associates latitude/longitude data with addresses, and also registers landmark data in which latitude/longitude data is associated with landmark names of buildings and places. The map data 312 stores data for displaying maps and data associated with positions on the map. The image files 313 are formatted in conformance with the Exchangeable Image File Format (EXIF) standardized by the Electronic Information Technology Industrial Association. Image files conforming to EXIF each are added with a geometric tag indicating the longitude and the latitude of a photo (or imaging) location.

The display processing module 301 displays user interfaces described later. After starting the route search program 202, the display processing module 301 displays a user interface as shown in FIG. 4. The user interface 400 shows an origin input column 401, an origin-image-file selection button 402, a destination input column 403, a destination-image-file selection button 404, a search start button 405, and a map area 406.

The origin input column 401 is provided in order that the user may input an address and a landmark of an origin. If latitude/longitude data can be determined from the GPS module 15, an origin-position-data determination module 302 obtains the latitude and the longitude from the GPS module 15, and sets the obtained latitude and longitude as latitude/longitude data of the origin.

The origin-position-data determination module 302 transfers the latitude/longitude data as the latitude/longitude data of the origin to the display processing module 301. The display processing module 301 displays the latitude/longitude data in the origin input column, and also displays a map image centered on a position corresponding to the latitude/longitude data in the map area 406.

If neither the latitude nor the longitude can be obtained from the GPS module 15 and if the user inputs an address or a landmark name into the origin input column 401, the origin-position-data determination module 302 searches for latitude/longitude data associated with the address or the landmark name input into the origin input column 401 from the address/landmark name database file 311. The origin-position-data determination module 302 transfers the latitude/longitude data searched for as the latitude/longitude data of the origin to the display processing module 301. The display processing module 301 displays a map image with a position corresponding to the latitude/longitude data centered in the map area 406.

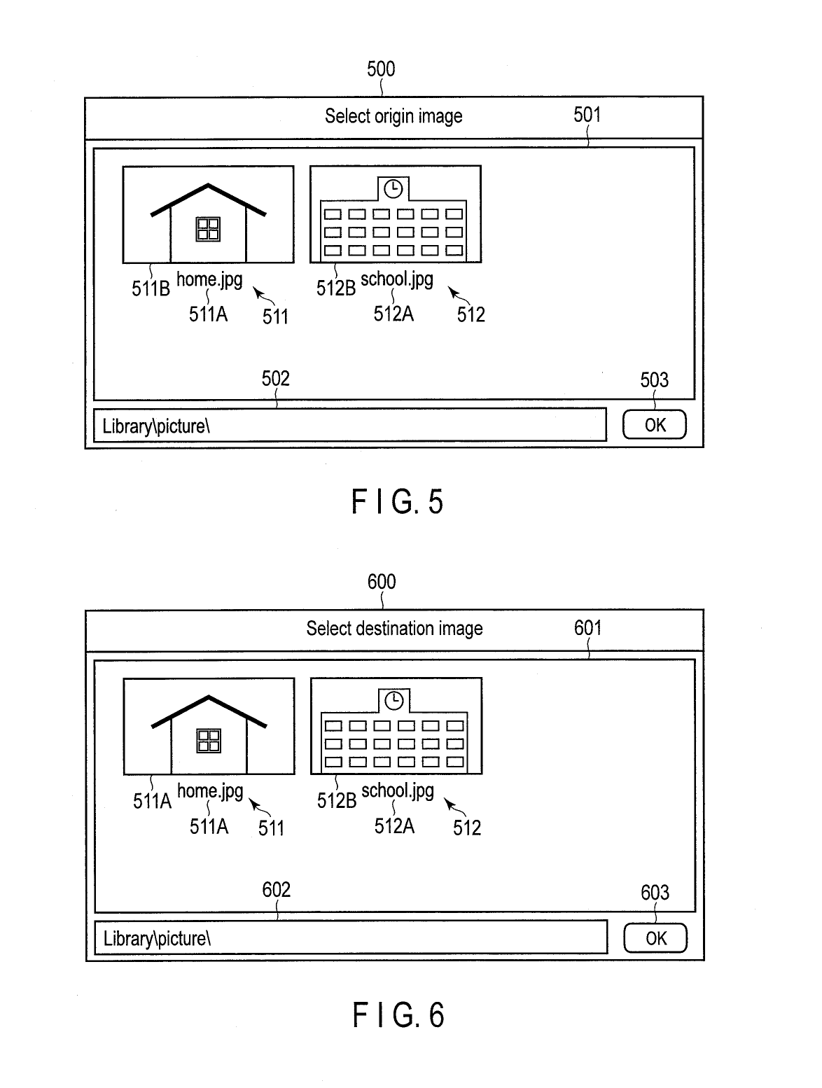

Otherwise, if neither the latitude nor the longitude can be obtained from the GPS module 15 and if the origin-image-file selection button 402 is operated, the display processing module 301 displays a user interface 500 as shown in FIG. 5. A file display part 501, a folder display part 502, and an enter button 503 are shown on the user interface 500.

Icons 511 and 512 indicating image files included in a folder currently shown in the folder display part 502 are displayed on the file display part 501. File names 511A and 511B and thumbnail images 512A and 512B are included respectively in the icons 511 and 512. When the enter button 503 is operated with an image file is selected, the origin-position-data determination module 302 then reads the selected image file, and obtains a geographical tag from the image file. The origin-position-data determination module 302 transfers, as the latitude/longitude data of the origin, latitude/longitude data included in the geographical tag to the display processing module 301.

The display processing module 301 displays again the user interface shown in FIG. 4. The display processing module 301 displays the latitude/longitude data in the origin input column, and also displays a map image with a position corresponding to the latitude/longitude data centered in the map area 406.

The destination input column 403 is provided in order that the user may input the address and landmark name of a destination. If the user inputs an address or a landmark name into the destination input column 403, the destination position data determination module 303 searches for latitude/longitude data associated with the address or the landmark name input into the destination input column 403 from the address/landmark name database file 311. The destination-position-data determination module 303 transfers the latitude/longitude data searched for, as the latitude/longitude data of the destination, to the display processing module 301. The display processing module 301 displays a map image with a position corresponding to the latitude/longitude data centered in the map area 406.

If the destination-image-file selection button 404 is operated, the display processing module 301 displays a user interface 600 as shown in FIG. 6. A file display part 601, a folder display part 602, and an enter button 603 are displayed on the user interface 600.

Icons 511 and 512 indicating image files included in a folder currently shown in the folder display part 602 are displayed on the file display part 601. File names 511A and 511B and thumbnail images 512A and 512B are included respectively in the icons 511 and 512. When the enter button 603 is operated with an image file is selected, the destination-position-data determination module 303 then reads the selected image file, and obtains a geographical tag from the image file. The destination-position-data determination module 303 transfers, as the latitude/longitude data of the destination, latitude/longitude data included in the geographical tag, to the display processing module 301.

The display processing module 301 displays again the user interface shown in FIG. 4. The display processing module 301 displays the latitude and the longitude in the destination input column 403, and also displays a map image with a position corresponding to the latitude/longitude data centered in the map area 406.

If the search start button 405 is operated, the origin-position-data entry module 302 transfers the destination position data to the route search module 304, and the destination-position-data entry module 303 transfers the destination position data to the route search module 304.

The route search module 304 searches for a route between the origin and the destination with reference to the map data 312.

The display processing module 301 displays the map image showing any route searched for on the touchscreen display 17.

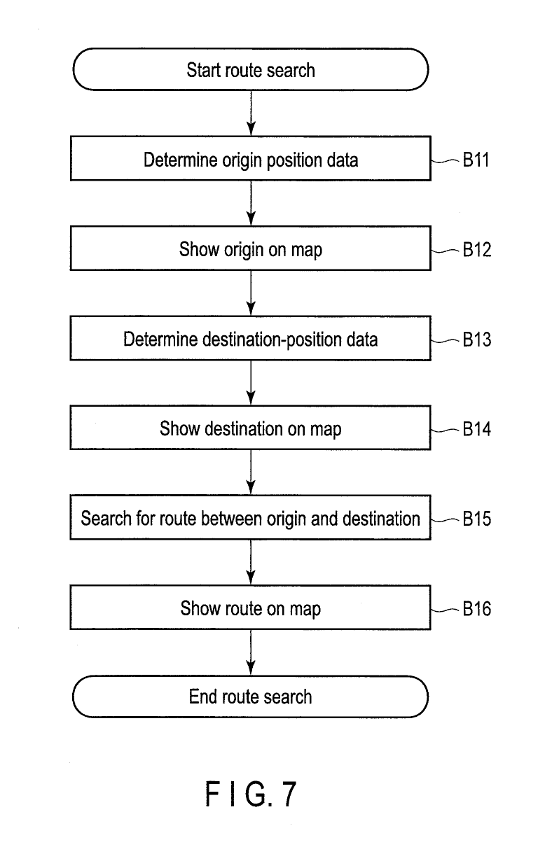

Next, a procedure of a route search will be described with reference to a flowchart shown in FIG. 7.

When the origin-position-data determination module 302 determines latitude/longitude data of an origin (Block B11), the display processing module 301 then displays a map image with the origin centered on the map area 406, based on the latitude/longitude data of the origin (Block B12). When the destination-position-data determination module 303 determines latitude/longitude data of a destination (Block B13), the display processing module 301 then displays a map image with the destination centered on the map area 406, based on the latitude/longitude data of the destination (Block B14).

When the search start button 405 is operated, the route search module 304 then searches for a route between the origin and the destination with reference to position data of the origin and destination (Block B15). The display processing module 301 displays a map image including a route searched for on the touchscreen display 17 (Block B16).

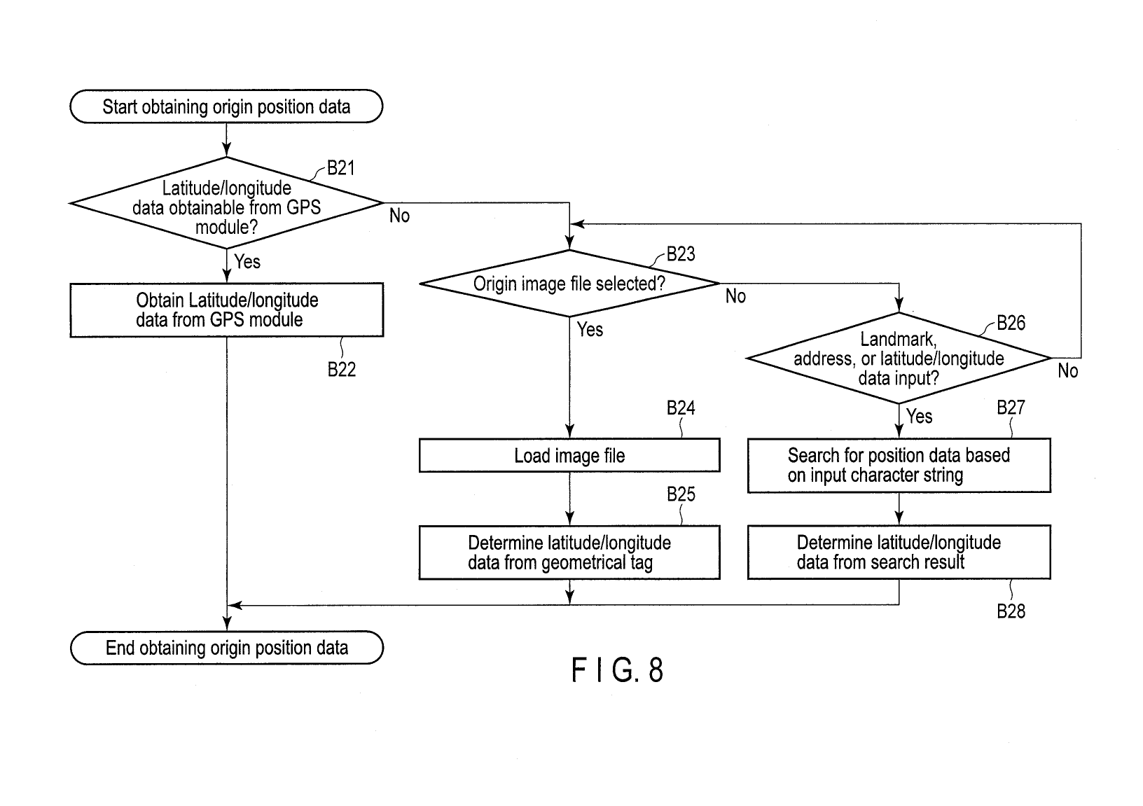

Next, a procedure of determining latitude/longitude data of an origin by the origin-position-data determination module 302 will be described with reference to FIG. 8.

The origin-position-data determination module 302 determines whether latitude/longitude data can be obtained from the GPS module 15 (Block B21). If the GPS module 15 operates and if the GPS module 15 can receive signals transmitted from four or more GPS satellites and measure the latitude and the longitude of the current position, the origin position data determination module 302 determines latitude/longitude data to be obtainable from the GPS module 15. If the GPS module 15 does not operate or if the GPS module 15, which operates, cannot receive signals transmitted from four or more GPS satellites and consequently cannot measure the latitude or the longitude of the current position, the origin position data determination module 302 determines latitude/longitude data to be not obtainable from the GPS module 15. If determined to be obtainable (Yes in Block B21), the origin-position-data determination module 302 obtains latitude/longitude data from the GPS module 15 (Block B22).

If determined to be obtainable (Yes in Block B21), the origin-position-data determination module 302 determines whether an image file of the origin has been selected (Block B23). If the image file of the origin is determined to have been selected (Yes in Block B23), the origin-position-data determination module 302 loads the selected image file (Block B24). The origin-position-data determination module 302 reads a geographical tag added to the image file, and determines latitude/longitude data of the origin from latitude/longitude included in the geographical tag (Block B25).

If the image file of the origin is determined to have not been selected (No in Block B23), the origin-position-data determination module 302 determines whether an address, a landmark name, or latitude/longitude data has been input into the origin input column 401 (Block B26) or not. The origin-position-data determination module 302 searches for position data from the address/landmark name database file 311, based on a character string input into the origin input column 401 (Block B27). The origin-position-data determination module 302 determines latitude/longitude data of the origin from a search result (Block B28).

Through the processings as described above, the origin-position-data determination module 302 determines the latitude/longitude data of the origin.

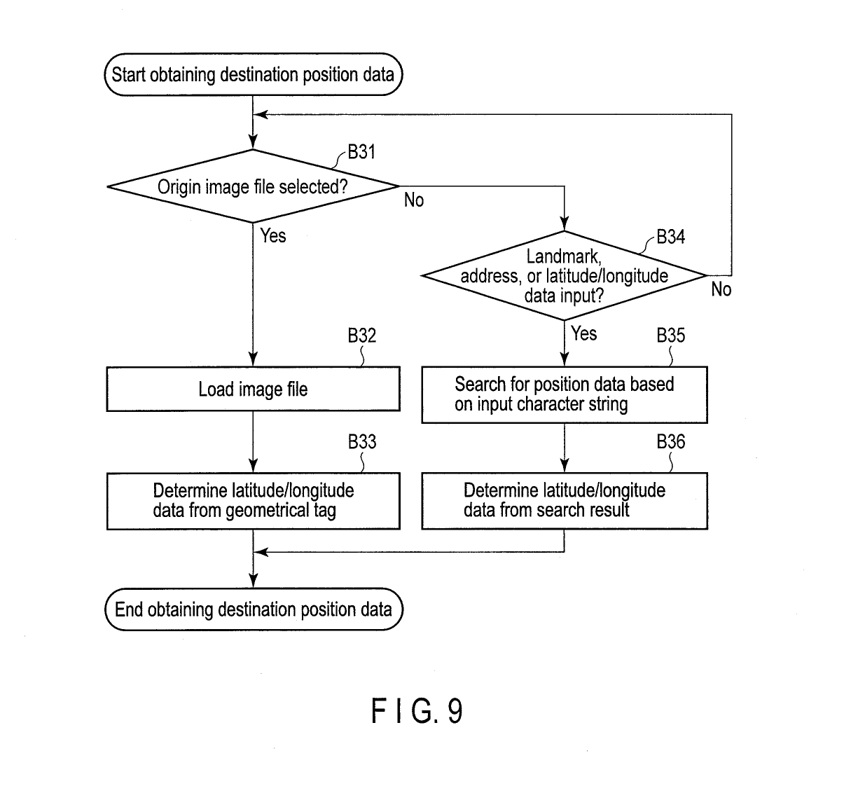

Next, a procedure of determining latitude/longitude data of a destination by the destination-position-data determination module 303 will be described with reference to FIG. 9.

The destination-position-data determination module 303 determines whether an image file of a destination has been selected (Block B31). If an image file of the destination is determined to have been selected (Yes in Block B31), the destination-position-data determination module 303 loads the selected image file (Block B32). The destination-position-data determination module 303 reads a geographical tag added to the image file, and determines latitude/longitude data of the destination from latitude/longitude included in the geographical tag (Block B33).

If the image file of the destination is determined to have not been selected (Yes in Block B31), the destination-position-data determination module 303 determines whether an address, a landmark name, or latitude/longitude data has been input into the destination input column 403 or not (Block B34). The destination-position-data determination module 303 searches for position data from the address/landmark name database file 311, based on a character string input into the destination input column 403 (Block B35). The destination-position-data determination module 303 determines latitude/longitude data of the destination from a search result (Block B36).

Through the processings as described above, the destination-position-data determination module 303 determines the latitude/longitude data of the destination.

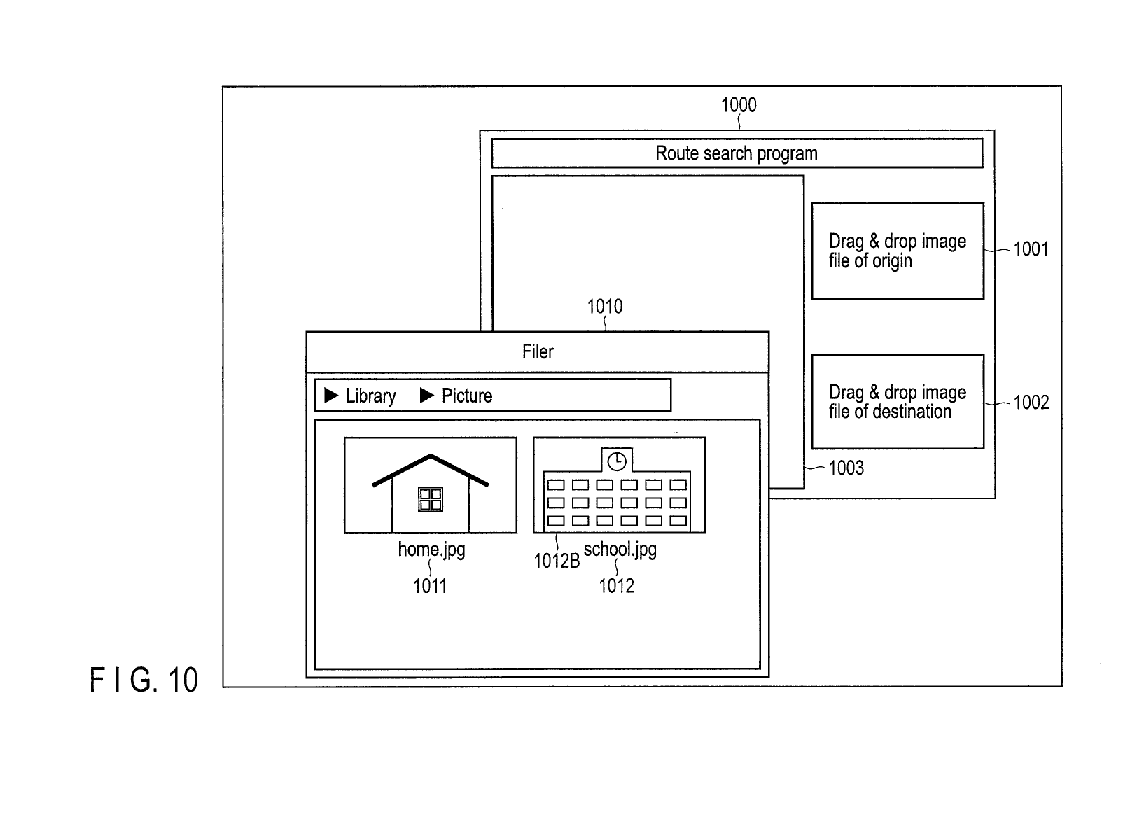

If the operating system supports multi-window, the display processing module 301 may display a window 1000 as shown in FIG. 10. In addition, a window 1010 is displayed over the window 1000 by a filer. In the window 1010, icons 1011 and 1012 indicating image files are displayed. An origin-image-file drag-and-drop region 1001, a destination-image-file drag-and-drop region 1002, and a map display region 1003 are shown in the window 1000.

When an icon corresponding to an image file is dragged and dropped into the origin-image-file drag-and-drop region 1001, the origin-position-data determination module 302 reads a geographical tag added to the image file, and determines latitude/longitude data of an origin from latitude/longitude included in the geographical tag. The display processing module 301 displays a map image with the origin centered on the map display region 1003, based on the latitude/longitude data of the origin.

When an icon corresponding to an image file is dragged and dropped into the destination-image-file drag-and-drop region 1002, the destination-position-data determination module 303 reads a geographical tag added to the image file, and determines latitude/longitude data of a destination from latitude/longitude included in the geographical tag. The display processing module 301 displays a map image with the destination centered in the map display region 1003, based on the latitude/longitude data of the destination.

In place of image files stored in the SSD, image files stored in a memory card inserted in the card slot 111 can be used.

According to the present apparatus, input of position data of an origin and/or the current position can be simplified by using geographical tags added to image files.

Since various processings for the route search according to the present embodiment can be achieved in form of a computer program, the same effects as those of the present embodiment can be easily achieved simply by installing and executing the computer program in an ordinary computer through a computer-readable storage medium which stores the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A route search apparatus, comprising:
an origin determination module configured to determine position of an origin, by using position data in a selected first image file and indicative of an imaging location of the first image file;
a destination determination module configured to determine position of a destination, by using position data in a selected second image file and indicative of an imaging location of the second image file; and
a search module configured to search for a route between the origin and the destination, based on the position of the origin and the position of the destination.

2. The apparatus of claim 1, wherein
the origin determination module is configured to determine the position of the origin, by using position data corresponding to an input character string.

3. The apparatus of claim 1, further comprising a Global Positioning System (GPS) module, wherein
the origin determination module determines the position of the origin when position data can be obtained from the GPS module,.

4. The apparatus of claim 1, wherein
the destination determination module is configured to determine the position of the destination, by using position data corresponding to an input character string.

5. The apparatus of claim 1, wherein
a format of the first and second image files is Exchangeable Image File Format.

6. A route search method, comprising:
determining position of an origin, by using position data in a selected first image file and indicative of an imaging location of the first image file;
determining position of a destination, by using position data in a selected second image file and indicative of an imaging location of the second image file; and
searching for a route between the origin and the destination, based on the position of the origin and the position of the destination.

7. A program which causes a computer to perform:
determining position of an origin, by using position data in a selected first image file and indicative of an imaging location of the first image file;
determining position of a destination, by using position data in a selected second image file and indicative of an imaging location of the second image file; and
searching for a route between the origin and the destination, based on the position of the origin and the position of the destination.
